(19) United States
(12) Patent Application Publication
(10) Pub. No.: US 2025/0069875 A1
(43) Pub. Date: Feb. 27, 2025

(54) METHOD FOR CHARACTERIZATION OF A MASS SPECTROMETRY INSTRUMENT COMPRISING AT LEAST ONE MASS ANALYZING CELL

(71) Applicant: Roche Diagnostics Operations, Inc., Indianapolis, IN (US)

(72) Inventors: Stefan Quint, Penzberg (DE); Florian Schweinberger, Penzberg (DE); Benjamin Tiemann, Penzberg (DE); Marius Wagner, Penzberg (DE)

(21) Appl. No.: 18/719,252

(22) PCT Filed: Dec. 13, 2022
(86) PCT No.: PCT/EP2022/085510

§ 371 Date: Jun. 12, 2024

(30) Foreign Application Priority Data
Dec. 13, 2021 (EP) 21214124.6

(51) Int. Cl. H01J 49/00

(52) U.S. Cl. CPC H01J 49/0036; H01J 49/0009

(57) ABSTRACT

A method for characterization of a mass spectrometry instrument (100) comprising at least one mass analyzing cell (102, 104, 106) is proposed. The method comprising the steps of analyzing a sample (110) comprising at least one substance having a known molecular weight by means of the mass spectrometry instrument (100) so as to provide a mass spectrum (116, 118, 144, 146) of the sample (110), determining an outer envelope and an inner envelope of the mass spectrum (116, 118, 144, 146), calculating a squared difference between the outer envelope and the inner envelope, and determining a deviation of the calculated squared difference from a theoretical mass to charge ratio value of the substance.

### TECHNICAL FIELD

The present disclosure relates to a method for characterization of a mass spectrometry instrument comprising at least one mass analyzing cell.

### BACKGROUND ART

There is growing interest for the implementation of mass spectrometry. Mass spectrometry (MS) is an analytical technique that is used to measure the mass-to-charge ratio of ions. The results are presented as a mass spectrum, a plot of intensity as a function of the mass-to-charge ratio. Mass spectrometry is used in many different fields and is applied to pure samples as well as complex mixtures.

A mass spectrum is a plot of the ion signal as a function of the mass-to-charge ratio. These spectra are used to determine the elemental or isotopic signature of a sample, the masses of particles and of molecules, and to elucidate the chemical identity or structure of molecules and other chemical compounds.

In a typical MS procedure, a sample, which may be solid, liquid, or gaseous, is ionized, for example by bombarding it with a beam of electrons. This may cause some of the sample's molecules to break up into positively charged fragments or simply become positively charged without fragmenting. These ions (fragments) are then separated according to their mass-to-charge ratio, for example by accelerating them and subjecting them to an electric or magnetic field: ions of the same mass-to-charge ratio will undergo the same amount of deflection. The ions are detected by a mechanism capable of detecting charged particles, such as an electron multiplier. Results are displayed as spectra of the signal intensity of detected ions as a function of the mass-to-charge ratio. The atoms or molecules in the sample can be identified by correlating known masses, e.g. an entire molecule, to the identified masses or through a characteristic fragmentation pattern.

A mass spectrometry instrument comprising at least one mass analyzing cell has a lot of different electronic potentials for guiding, filtering and at least detecting the ions. The system parameters should harmonize the behavior of same ions over different systems. The mass calibration parameters are correlating the weight of ions and their resolution to the applied voltages. Due to the environmental condition changes and contamination of the system over time, the mass calibration can undergo different variances, shifts and trends, which can have a negative impact on selectivity, sensitivity and furthermore in worst case on the patient result.

### Problem to Be Solved

It is therefore desirable to provide an automatic classification of the mass spectrometry instrument state such as normal and abnormal.

### SUMMARY

This problem is addressed by a method for characterization of a mass spectrometry instrument comprising at least one mass analyzing cell, a computer program and computer-readable storage medium with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such way with other optional or non-optional features of the invention.

Further, it shall be noted that the terms “first”, “second”, “third”, “fourth” or similar expressions as used herein merely serve for distinguishing features or constructional members. It is explicitly stated that these terms are not intended to define a certain order of importance or relevance.

In a first aspect, a method for characterization of a mass spectrometry instrument comprising at least one mass analyzing cell is proposed.

The term “mass spectrometry instrument” as used herein is a broad term and is to be given its ordinary and customary meaning to a person of ordinary skill in the art and is not to be limited to a special or customized meaning. The term specifically may refer, without limitation, to a mass analyzer used in mass spectrometry. Mass spectrometry (MS) is an analytical technique that is used to measure the mass-to-charge ratio of ions. The results are presented as a mass spectrum, a plot of intensity as a function of the mass-to-charge ratio. Mass spectrometry is used in many different fields and is applied to pure samples as well as complex mixtures. A mass spectrum is a plot of the ion signal as a function of the mass-to-charge ratio. These spectra are used to determine the elemental or isotopic signature of a sample, the masses of particles and of molecules, and to elucidate the chemical identity or structure of molecules and other chemical compounds. In a typical MS procedure, a sample, which may be solid, liquid, or gaseous, is ionized, for example by bombarding it with a beam of electrons. This may cause some of the sample's molecules to break up into positively charged fragments or simply become positively charged without fragmenting. These ions (fragments) are then separated according to their mass-to-charge ratio, for example by accelerating them and subjecting them to an electric or magnetic field: ions of the same mass-to-charge ratio will undergo the same amount of deflection. The ions are detected by a mechanism capable of detecting charged particles, such as an electron multiplier. Results are displayed as spectra of the signal intensity of detected ions as a function of the mass-to-charge ratio. The atoms or molecules in the sample can be identified by correlating known masses (e.g. an entire molecule) to the identified masses or through a characteristic fragmentation pattern.

The term “analyzing cell” as used herein is a broad term and is to be given its ordinary and customary meaning to a person of ordinary skill in the art and is not to be limited to a special or customized meaning. The term specifically may refer, without limitation, to a portion of a mass spectrometer that takes part in mass resolving. Thus, the analyzing cell can resolve the mass of a sample or prepares or facilitates mass resolving.

The term “characterization” as used herein is a broad term and is to be given its ordinary and customary meaning to a person of ordinary skill in the art and is not to be limited to a special or customized meaning. The term specifically may refer, without limitation, to a determination or detection of a state of the mass spectrometry instrument. In a simple application, the determination or detection may reveal a normal or abnormal state.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
analyzing a sample comprising at least one substance having a known molecular weight by means of the mass spectrometry instrument so as to provide a mass spectrum of the sample,
determining an outer envelope and an inner envelope of the mass spectrum,
calculating a squared difference between the outer envelope and the inner envelope, and
determining a deviation of the calculated squared difference from a theoretical mass to charge ratio value of the substance.

The term “analyzing” and its grammatical equivalents as used herein is a broad term and is to be given its ordinary and customary meaning to a person of ordinary skill in the art and is not to be limited to a special or customized meaning. The term specifically may refer, without limitation, to a process of measuring a mass-to-charge ratio of ions.

The term “sample” as used herein refers to a biological material suspected of containing one or more analytes of interest and whose detection, qualitative and/or quantitative, may be associated to a clinical condition. The sample can be derived from any biological source, such as a physiological fluid, including, blood, saliva, ocular lens fluid, cerebral spinal fluid, sweat, urine, milk, ascites fluid, mucous, synovial fluid, peritoneal fluid, amniotic fluid, tissue, cells or the like. The sample can be pretreated prior to use, such as preparing plasma from blood, diluting viscous fluids, lysis or the like; methods of treatment can involve filtration, centrifugation, distillation, concentration, inactivation of interfering components, and the addition of reagents. A sample may be used directly as obtained from the source in some cases or following a pretreatment and/or sample preparation workflow to modify the character of the sample, e.g. after adding an internal standard, after being diluted with another solution or after having being mixed with reagents e.g. to enable carrying out one or more in vitro diagnostic tests, or for enriching (extracting/separating/concentrating) analytes of interest and/or for removing matrix components potentially interfering with the detection of the analyte(s) of interest. The term “sample” is tendentially used to indicate a sample before sample preparation whereas the term “prepared sample” is used to refer to samples after sample preparation. In non-specified cases the term “sample” may generally indicate either a sample before sample preparation or a sample after sample preparation or both. Examples of analytes of interest are vitamin D, drugs of abuse, therapeutic drugs, hormones, and metabolites in general. The list is however not exhaustive.

The term “envelope” as used herein is a broad term and is to be given its ordinary and customary meaning to a person of ordinary skill in the art and is not to be limited to a special or customized meaning. The term specifically may refer, without limitation, to a curve that is tangent to each member of a family of curves at some point, and these points of tangency together form the whole envelope. Classically, a point on the envelope can be thought of as the intersection of two “infinitesimally adjacent” curves, meaning the limit of intersections of nearby curves. This idea can be generalized to an envelope of surfaces in space, and so on to higher dimensions. To have an envelope, it is necessary that the individual members of the family of curves are differentiable curves as the concept of tangency does not apply otherwise, and there has to be a smooth transition proceeding through the members. But these conditions are not sufficient—a given family may fail to have an envelope. A simple example of this is given by a family of concentric circles of expanding radius. Depending on whether that curve is located above or below the family of curves, it is called upper or lower envelope.

By closely monitoring the status for example during the start up process, an automatic classification of the systems state (normal/abnormal) is possible with “noise-limits”. An identification of an abnormal state can prevent wrong patient results. Further, a check of proper insulation of the electric circuitry or the quality of the used electric components is possible. The correct labeling of the status (e.g. shifts of position, resolution and envelopes) can be used to trigger the correct maintenance actions and thus decreasing system down time and service costs. From a manufacturer point of view, this method could be helpful in order to select the correct quadrupole rods and help in the assembly process.

The squared difference between the outer envelope and the inner envelope may be calculated as (fₒ−fᵢ)², wherein fₒ is the outer envelope and fᵢ is the inner envelope. This specific calculation of the squared difference provides that differences between the outer envelope and the inner envelope are weighted more than formation of a simple difference. Thus, a potential unbalance between the sides of a peak can be better illustrated or shown. Further, this calculation facilitates to better distinguish between mass spectrum of an ion and noise in the region around an ion.

The method may further comprise determining the deviation of the calculated difference along a mass to charge ratio axis of the mass spectrum. Thus, not only a single point of the signal is observed but a range along the mass to charge ratio axis of the mass spectrum which allows a more precise monitoring of the status of the mass spectrometry instrument.

The method may further comprise determining the deviation of the calculated difference based on a position left and a position right of the theoretical mass value of the substance along the mass to charge ratio axis of the mass spectrum. Thus, left and right sides of a peak of the theoretical mass value of the substance in the mass spectrum are observed. Thereby, any potential asymmetrical signal can be observed giving hints for an improper status of the mass spectrometry instrument.

Determining the deviation may include determining a ratio of the peak at the position left and the peak at the position right of the theoretical mass value of the substance along the mass to charge ratio axis of the mass spectrum. Thus, left and right sides of a peak of the theoretical mass value of the substance in the mass spectrum are observed. A ratio of the signal heights at the left and right positions should be approximately 1 if the peak is symmetrical. In case of an asymmetric signal peak, the ratio of the signal heights at the left and right positions significantly differs from 1 and may be 2, 3 or even more.

The method may further comprise determining an improper status of the mass spectrometry instrument if the determined deviation of the calculated difference exceeds a predetermined difference threshold. Thus, a clear decision on the status of the mass spectrometry instrument can be made.

The method may further comprise making a wavelet transformation of the mass spectrum, and determining a deviation of an amplitude of the wavelet transformed mass spectrum from a theoretical amplitude value of the substance at a predetermined period. This allows a rather microscopic observation of the mass spectrum and the status of the mass spectrometry instrument.

The term “wavelet transformation” and its grammatical equivalents as used herein is a broad term and is to be given its ordinary and customary meaning to a person of ordinary skill in the art and is not to be limited to a special or customized meaning. The term specifically may refer, without limitation, to a representation of a square-integrable (real-or complex-valued) function by a certain orthonormal series generated by a wavelet. This article provides a formal, mathematical definition of an orthonormal wavelet and of the integral wavelet transform. A wavelet is a wave-like oscillation with an amplitude that begins at zero, increases, and then decreases back to zero. It can typically be visualized as a “brief oscillation” like one recorded by a seismograph or heart monitor. Generally, wavelets are intentionally crafted to have specific properties that make them useful for signal processing. The fundamental idea of wavelet transforms is that the transformation should allow only changes in time extension, but not shape. This is affected by choosing suitable basis functions that allow for this. Changes in the time extension are expected to conform to the corresponding analysis frequency of the basis function. Based on the uncertainty principle of signal processing,

Making the wavelet transformation of the mass spectrum, and determining the deviation of an amplitude of the wavelet transformed mass spectrum from a theoretical amplitude value of the substance at a predetermined period may be carried out if the determined deviation of the calculated difference does not exceed the predetermined difference threshold. Thus, if the rather macroscopic observation of the envelopes is rather unobtrusive, a closer or more microscopic look at the mass spectrum can be made allowing to detect even smaller deviations form a target status of the mass spectrometry instrument.

The method may further comprise determining an improper status of the mass spectrometry instrument if the determined deviation of the amplitude exceeds a predetermined amplitude threshold. Thus, a clear decision on the status of the mass spectrometry instrument can be made.

In a second aspect, a method for characterization of a mass spectrometry instrument comprising at least one mass analyzing cell is proposed.

The method comprises the following method steps which, specifically, may be performed in the given order. Still, a different order is also possible. It is further possible to perform two or more of the method steps fully or partially simultaneously. Further, one or more or even all of the method steps may be performed once or may be performed repeatedly, such as repeated once or several times. Further, the method may comprise additional method steps which are not listed.

The method comprises the following steps:
analyzing a sample comprising at least one substance having a known molecular weight by means of the mass spectrometry instrument so as to provide a mass spectrum of the sample,
making a wavelet transformation of the mass spectrum, and
determining a deviation of an amplitude of the wavelet transformed mass spectrum from a theoretical amplitude value of the substance at a predetermined period.

In this respect, it is explicitly stated that the method of the second aspect may be combined with the method of the first aspect. Particularly, the method of the second aspect may be carried out subsequent to the method of the fist aspect, for example if a deviation of the calculated squared difference from a theoretical mass to charge ratio value of the substance may not be determined with the method of the first aspect. Thus, the method of the second aspect allows to have a closer look to the status of the mass spectrometer.

The method may further comprises creating a heatmap of the wavelet transformed mass spectrum and determining the deviation of the amplitude at the predetermined period in the heatmap. Such a heatmap allows to observe highly effected regions of the wavelet transformed mass spectrum.

The term “heatmap” as used herein is a broad term and is to be given its ordinary and customary meaning to a person of ordinary skill in the art and is not to be limited to a special or customized meaning. The term specifically may refer, without limitation, to a data visualization technique that shows magnitude of a phenomenon as color in two dimensions. The variation in color may be by hue or intensity, giving obvious visual cues to the reader about how the phenomenon is clustered or varies over space. There are two fundamentally different categories of heat maps: the cluster heat map and the spatial heat map. In a cluster heat map, magnitudes are laid out into a matrix of fixed cell size whose rows and columns are discrete phenomena and categories, and the sorting of rows and columns is intentional and somewhat arbitrary, with the goal of suggesting clusters or portraying them as discovered via statistical analysis. The size of the cell is arbitrary but large enough to be clearly visible. By contrast, the position of a magnitude in a spatial heat map is forced by the location of the magnitude in that space, and there is no notion of cells; the phenomenon is considered to vary continuously.

With the use of wavelets, the heatmap is also known as scalogram. In a scalogram, the result of a wavelet transformation is visualized as a graph in three dimensions. The first spatial dimension is the definition range of the signal, which is the mass to charge ratio m/z on the x-axis as used herein. The second spatial dimension is the frequency or period of the signal on the y-axis. The third spatial dimension represents the amplitude, i.e. wavelet power, of a certain period associated with a certain position in the definition range, i.e. m/z. The latter one is not represented in a spatial manner but in a coloured manner, particularly grey for lower amplitudes and white for higher amplitudes.

The term “period” as used herein is a broad term and is to be given its ordinary and customary meaning to a person of ordinary skill in the art and is not to be limited to a special or customized meaning. The term specifically may refer, without limitation, to periodic signal parts located in the frequency range as well as in the definition range of the signal. Thus, potential variations of the frequency across the frequency range may be illustrated and salient frequencies may be unambiguously associated with certain portions of the definition range.

The method may further comprise determining the deviation of the amplitude at the predetermined period depending on a wavelet power.

The term “wavelet power” as used herein is a broad term and is to be given its ordinary and customary meaning to a person of ordinary skill in the art and is not to be limited to a special or customized meaning. The term specifically may refer, without limitation, to the amplitude of a certain period associated with a certain position in the definition range of a wavelet transformed mass spectrum. Thus, the amount of a certain periodic signal portion may be visualized if compared to all other periodic signal portions. Therefore, a relative illustration is possible which allows to derive the amount of a certain frequency in a signal.

The method may further comprise determining an improper status of the mass spectrometry instrument if the determined deviation of the amplitude exceeds a predetermined amplitude threshold. Thus, a clear decision on the status of the mass spectrometry instrument can be made.

The mass analyzing cell may be a quadrupole. Thus, the mass spectrometry instrument may be a so called quadrupole mass analyzer. Thus, samples may be analyzed with a high resolution.

The term “quadrupole mass analyzer” as used herein is a broad term and is to be given its ordinary and customary meaning to a person of ordinary skill in the art and is not to be limited to a special or customized meaning. The term specifically may refer, without limitation, to one type of mass analyzer used in mass spectrometry. The quadrupole mass analyzer (QMS) is also known as a transmission quadrupole mass spectrometer, quadrupole mass filter, or quadrupole mass. As the name implies, it consists of four cylindrical rods, set parallel to each other. In a quadrupole mass spectrometer the quadrupole is the mass analyzer—the component of the instrument responsible for selecting sample ions based on their mass-to-charge ratio (m/z). Ions are separated in a quadrupole based on the stability of their trajectories in the oscillating electric fields that are applied to the rods. The quadrupole consists of four parallel metal rods. Each opposing rod pair is connected together electrically, and a radio frequency (RF) voltage with a DC offset voltage is applied between one pair of rods and the other. Ions travel down the quadrupole between the rods. Only ions of a certain mass-to-charge ratio will reach the detector for a given ratio of voltages: other ions have unstable trajectories and will collide with the rods. This permits selection of an ion with a particular m/z or allows the operator to scan for a range of m/z-values by continuously varying the applied voltage. Mathematically this can be modeled with the help of the Mathieu differential equation. Ideally, the rods are hyperbolic, however cylindrical rods with a specific ratio of rod diameter-to-spacing provide an easier-to-manufacture adequate approximation to hyperbolas. Small variations in the ratio have large effects on resolution and peak shape. Different manufacturers choose slightly different ratios to fine-tune operating characteristics in context of anticipated application requirements.

The mass spectrometry instrument may comprise more than one mass analyzing cell, wherein the method may be carried out for each mass analyzing cell.

For example, the mass spectrometry instrument may be a so called triple quadrupole mass spectrometer (TQMS). The term “triple quadrupole mass spectrometer” as used herein is a broad term and is to be given its ordinary and customary meaning to a person of ordinary skill in the art and is not to be limited to a special or customized meaning. The term specifically may refer, without limitation, to a tandem mass spectrometer consisting of two quadrupole mass analyzers in series, with a (non-mass-resolving) radio frequency (RF)-only quadrupole between them to act as a cell for collision-induced dissociation. This configuration is often abbreviated QqQ, here Q_{1q2}Q₃. Essentially the triple quadrupole mass spectrometer operates under the same principle as the single quadrupole mass analyzer. Each of the two mass filters (Q1 and Q3) contains four parallel, cylindrical metal rods. Both Q1 and Q3 are controlled by direct current (dc) and radio-frequency (rf) potentials, while the collision cell, q, is only subjected to RF potential. The RF potential associated with the collision cell (q) allows all ions that were selected for to pass through it. In some instruments, the normal quadrupole collision cell has been replaced by hexapole or octopole collision cells which improve efficiency.

Unlike traditional MS techniques, MS/MS techniques allow for mass analysis to occur in a sequential manner in different regions of the instruments. The TQMS follows the tandem-in-space arrangement, due to ionization, primary mass selection, collision induced dissociation (CID), mass analysis of fragments produced during CID, and detection occurring in separate segments of the instrument. Sector instruments tend to surpass the TQMS in mass resolution and mass range. However, the triple quadrupole has the advantage of being cheaper, easy to operate and highly efficient. Also, when operated in the selected reaction monitoring mode, the TQMS has superior detection sensitivity as well as quantification. The triple quadrupole allows the study of low-energy low-molecule reactions, which is useful when small molecules are being analyzed.

The method may be carried out at predetermined points of time. Particularly, the points of time may include at least a start of the mass spectrometry instrument. Thus, the status may be checked at regular intervals or the like.

The method may further comprise carrying out the method as a predictive maintenance measure. Thus, any defect constructional members of the mass spectrometry instrument may be replaced before the whole mass spectrometry instrument is defect.

The method may be computer-implemented. The term “computer-implemented” as used herein is a broad term and is to be given its ordinary and customary meaning to a person of ordinary skill in the art and is not to be limited to a special or customized meaning. The term specifically may refer, without limitation, to a process which is fully or partially implemented by using a data processing means, such as data processing means comprising at least one processing unit, in particular of the focus electronics and control system. The term “computer”, thus, may generally refer to a device or to a combination or network of devices having at least one data processing means such as at least one processing unit. The computer, additionally, may comprise one or more further components, such as at least one of a data storage device, an electronic interface or a human-machine interface.

In a further aspect, a computer program comprising instructions is proposed which, when the program is executed by a mass spectrometry instrument comprising at least one mass analyzing cell, cause the mass spectrometry instrument to perform the method according to any one of the preceding claims referring to a method.

In a further aspect, a computer-readable storage medium comprising instructions is proposed which, when the program is executed by a mass spectrometry instrument comprising at least one mass analyzing cell, cause the mass spectrometry instrument to perform the method according to any one of the preceding claims referring to a method.

The term “moving average” as used herein is a broad term and is to be given its ordinary and customary meaning to a person of ordinary skill in the art and is not to be limited to a special or customized meaning. The term specifically may refer, without limitation, to a calculation to analyze data points by creating a series of averages of different subsets of the full data set. It is also called a moving mean (MM) or rolling mean and is a type of finite impulse response filter. Variations include: simple, cumulative, or weighted forms. Given a series of numbers and a fixed subset size, the first element of the moving average is obtained by taking the average of the initial fixed subset of the number series. Then the subset is modified by “shifting forward”; that is, excluding the first number of the series and including the next value in the subset. A moving average is commonly used with time series data to smooth out short-term fluctuations and highlight longer-term trends or cycles. The threshold between short-term and long-term depends on the application, and the parameters of the moving average will be set accordingly. For example, it is often used in technical analysis of financial data, like stock prices, returns or trading volumes. It is also used in economics to examine gross domestic product, employment or other macroeconomic time series. Mathematically, a moving average is a type of convolution and so it can be viewed as an example of a low-pass filter used in signal processing. When used with non-time series data, a moving average filters higher frequency components without any specific connection to time, although typically some kind of ordering is implied. Viewed simplistically it can be regarded as smoothing the data.

Further disclosed and proposed herein is a computer program including computer-executable instructions for performing the method according to the present invention in one or more of the embodiments enclosed herein when the program is executed on a computer or computer network. Specifically, the computer program may be stored on a computer-readable data carrier and/or on a computer-readable storage medium.

As used herein, the terms “computer-readable data carrier” and “computer-readable storage medium” specifically may refer to non-transitory data storage means, such as a hardware storage medium having stored thereon computer-executable instructions. The computer-readable data carrier or storage medium specifically may be or may comprise a storage medium such as a random-access memory (RAM) and/or a read-only memory (ROM).

Thus, specifically, one, more than one or even all of method steps a) to d) as indicated above may be performed by using a computer or a computer network, preferably by using a computer program.

Further disclosed and proposed herein is a computer program product having program code means, in order to perform the method according to the present invention in one or more of the embodiments enclosed herein when the program is executed on a computer or computer network. Specifically, the program code means may be stored on a computer-readable data carrier and/or on a computer-readable storage medium.

Further disclosed and proposed herein is a data carrier having a data structure stored thereon, which, after loading into a computer or computer network, such as into a working memory or main memory of the computer or computer network, may execute the method according to one or more of the embodiments disclosed herein.

Further disclosed and proposed herein is a computer program product with program code means stored on a machine-readable carrier, in order to perform the method according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier and/or on a computer-readable storage medium. Specifically, the computer program product may be distributed over a data network.

Finally, disclosed and proposed herein is a modulated data signal which contains instructions readable by a computer system or computer network, for performing the method according to one or more of the embodiments disclosed herein.

Referring to the computer-implemented aspects of the invention, one or more of the method steps or even all of the method steps of the method according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, further disclosed herein are:
a computer or computer network comprising at least one processor, wherein the processor is adapted to perform the method according to one of the embodiments described in this description,
a computer loadable data structure that is adapted to perform the method according to one of the embodiments described in this description while the data structure is being executed on a computer,
a computer program, wherein the computer program is adapted to perform the method according to one of the embodiments described in this description while the program is being executed on a computer,
a computer program comprising program means for performing the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform the method according to one of the embodiments described in this description after having been loaded into a main and/or working storage of a computer or of a computer network, and
a computer program product having program code means, wherein the program code means can be stored or are stored on a storage medium, for performing the method according to one of the embodiments described in this description, if the program code means are executed on a computer or on a computer network.

Summarizing and without excluding further possible embodiments, the following embodiments may be envisaged:

Embodiment 1: A method for characterization of a mass spectrometry instrument comprising at least one mass analyzing cell, the method comprising
analyzing a sample comprising at least one substance having a known molecular weight by means of the mass spectrometry instrument so as to provide a mass spectrum of the sample,
determining an outer envelope and an inner envelope of the mass spectrum,
calculating a squared difference between the outer envelope and the inner envelope, and
determining a deviation of the calculated squared difference from a theoretical mass to charge ratio value of the substance.

Embodiment 2: The method according to the preceding claim, wherein the squared difference between the outer envelope and the inner envelope is calculated as (fₒ−fᵢ)², wherein fₒ is the outer envelope and fᵢ is the inner envelope.

Embodiment 3: The method according to anyone of the preceding claims, further comprising determining the deviation of the calculated difference along a mass to charge ratio axis of the mass spectrum.

Embodiment 4: The method according to the preceding claim, further comprising determining the deviation of the calculated difference based on a position left and a position right of the theoretical mass value of the substance along the mass to charge ratio axis of the mass spectrum.

Embodiment 5: The method according to the preceding claim, wherein determining the deviation includes determining a ratio of the peak at the position left and the peak at the position right of the theoretical mass value of the substance along the mass to charge ratio axis of the mass spectrum.

Embodiment 6: The method according to anyone of the preceding claims, further comprising determining an improper status of the mass spectrometry instrument if the determined deviation of the calculated difference exceeds a predetermined difference threshold.

Embodiment 7: The method according to the preceding claim, further comprising making a wavelet transformation of the mass spectrum, and determining a deviation of an amplitude of the wavelet transformed mass spectrum from a theoretical amplitude value of the substance at a predetermined period.

Embodiment 8: The method according to the preceding claim, wherein making the wavelet transformation of the mass spectrum, and determining the deviation of an amplitude of the wavelet transformed mass spectrum from a theoretical amplitude value of the substance at a predetermined period is carried out if the determined deviation of the calculated difference does not exceed the predetermined difference threshold.

Embodiment 9: The method according to the preceding claim, further comprising determining an improper status of the mass spectrometry instrument if the determined deviation of the amplitude exceeds a predetermined amplitude threshold.

Embodiment 10: A method for characterization of a mass spectrometry instrument comprising at least one mass analyzing cell, the method comprising
analyzing a sample comprising at least one substance having a known molecular weight by means of the mass spectrometry instrument so as to provide a mass spectrum of the sample,
making a wavelet transformation of the mass spectrum, and
determining a deviation of an amplitude of the wavelet transformed mass spectrum from a theoretical amplitude value of the substance at a predetermined period.

Embodiment 11: The method according to the preceding claim, further comprising creating a heatmap of the wavelet transformed mass spectrum and determining the deviation of the amplitude at the predetermined period in the heatmap.

Embodiment 12: The method according to anyone of the two preceding claims, further comprising determining the deviation of the amplitude at the predetermined period depending on a wavelet power.

Embodiment 13: The method according to anyone of the preceding claims, further comprising determining an improper status of the mass spectrometry instrument if the determined deviation of the amplitude exceeds a predetermined amplitude threshold.

Embodiment 14: The method according to anyone of the preceding claims, wherein the mass spectrometry instrument comprises more than one mass analyzing cell, wherein the method is carried out for each mass analyzing cell.

Embodiment 15: The method according to the preceding claim, wherein the mass analyzing cell is a quadrupole.

Embodiment 16: The method according to anyone of the preceding claims, wherein the method is carried out at predetermined points of time.

Embodiment 17: The method according to the preceding claim, wherein the points of time include at least a start of the mass spectrometry instrument.

Embodiment 18: The method according to anyone of the preceding claims, further comprising carrying out the method as a predictive maintenance measure.

Embodiment 19: The method according to anyone of the preceding method claims, wherein the method is computer-implemented.

Embodiment 20: A computer program comprising instructions which, when the program is executed by a mass spectrometry instrument comprising at least one mass analyzing cell, cause the mass spectrometry instrument to perform the method according to any one of the preceding claims referring to a method.

Embodiment 21: A computer-readable storage medium comprising instructions which, when the program is executed by a mass spectrometry instrument comprising at least one mass analyzing cell, cause the mass spectrometry instrument to perform the method according to any one of the preceding claims referring to a method.

### Short Description of the Figures

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

### IN THE FIGURES

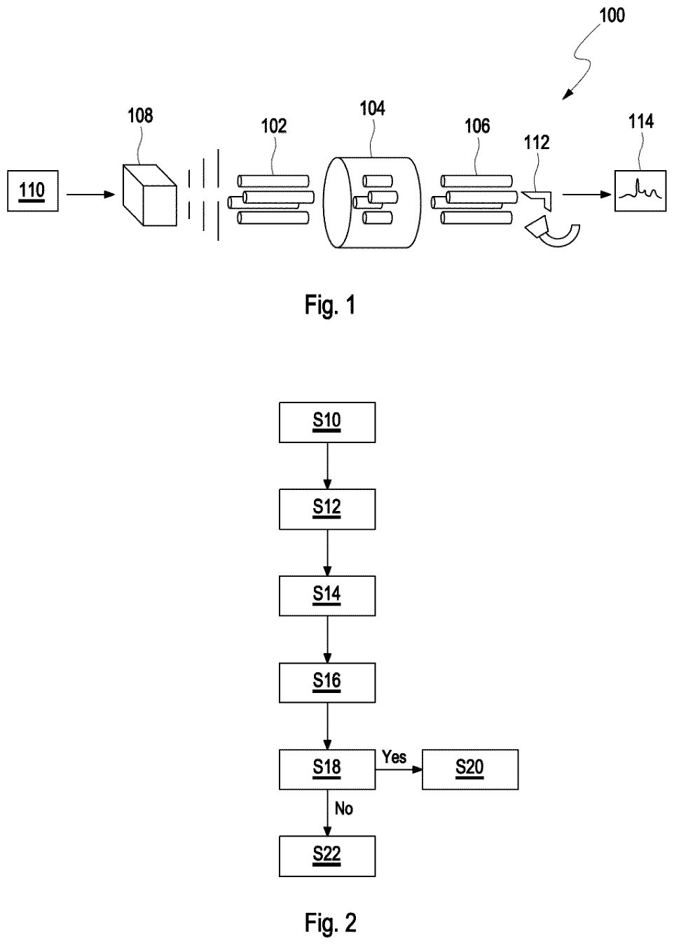

FIG. 1 shows a schematic illustration mass spectrometry instrument;

FIG. 2 shows a flow chart of a method for characterization of a mass spectrometry instrument according to a first embodiment;

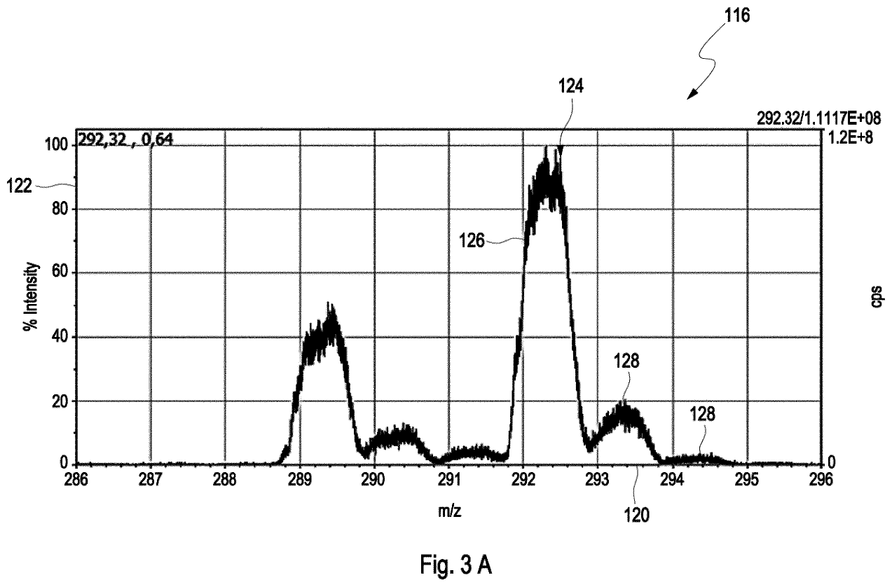

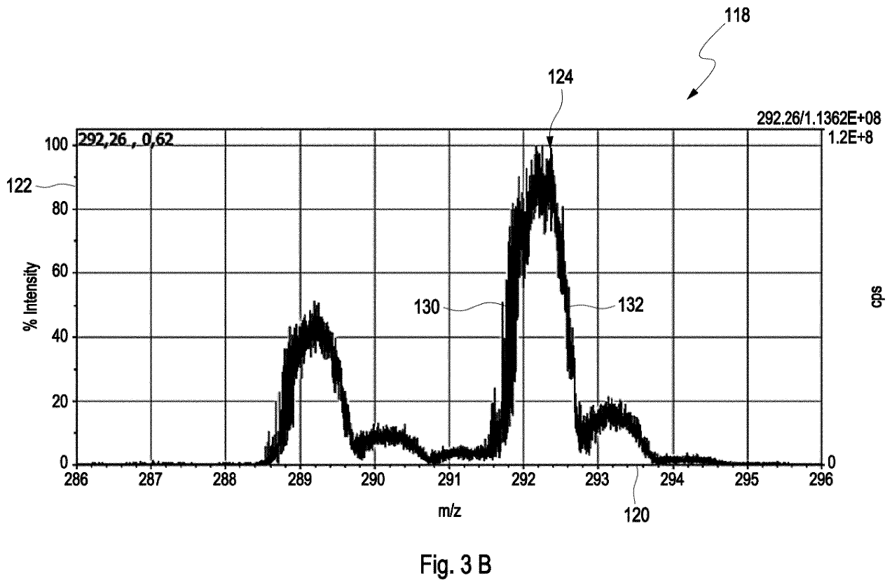

FIG. 3A shows an exemplary first mass spectrum of the first analyzing cell;

FIG. 3B shows an exemplary second mass spectrum of the third analyzing cell;

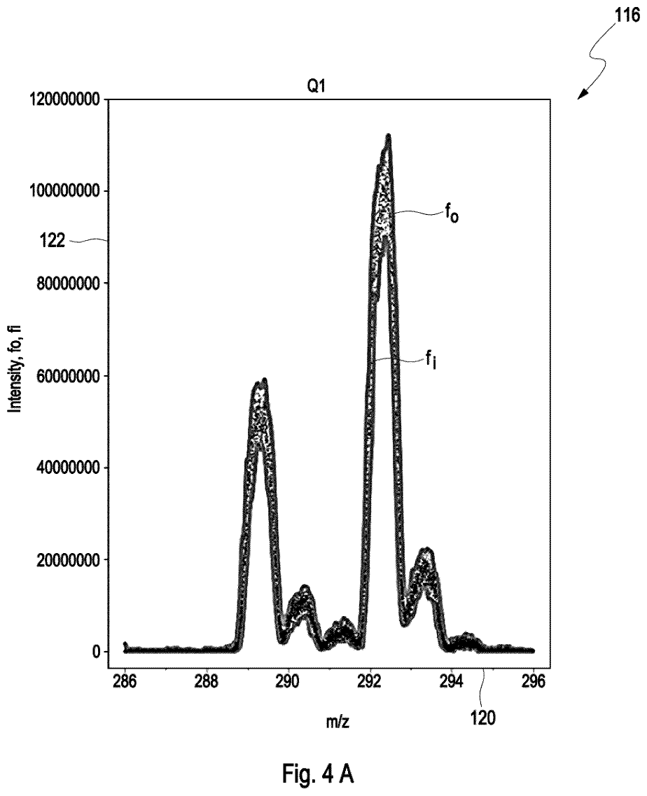

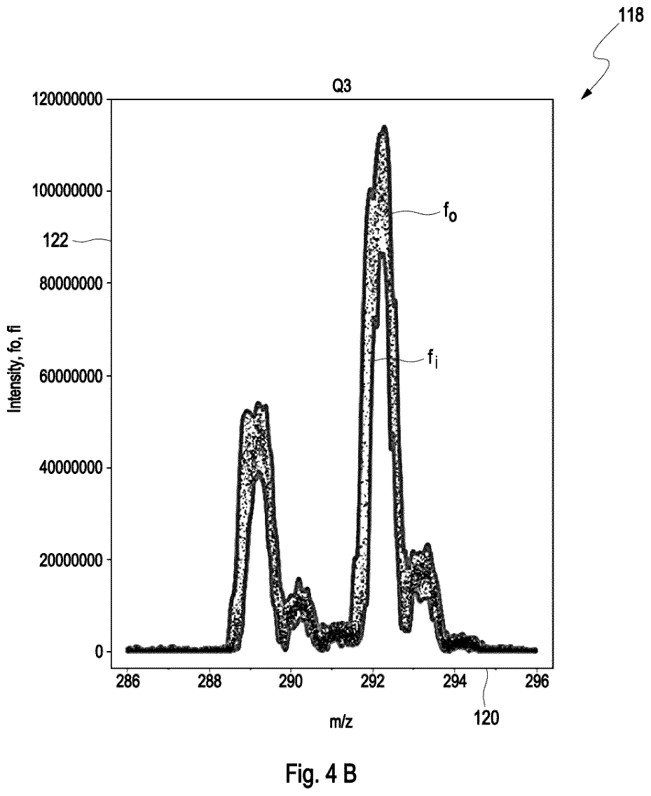

FIG. 4A shows an exemplary first mass spectrum of the first analyzing cell;

FIG. 4B shows an exemplary second mass spectrum of the third analyzing cell;

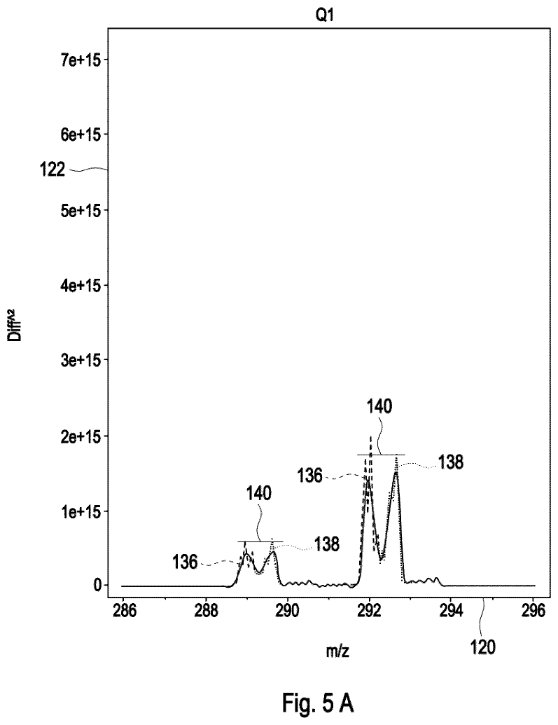

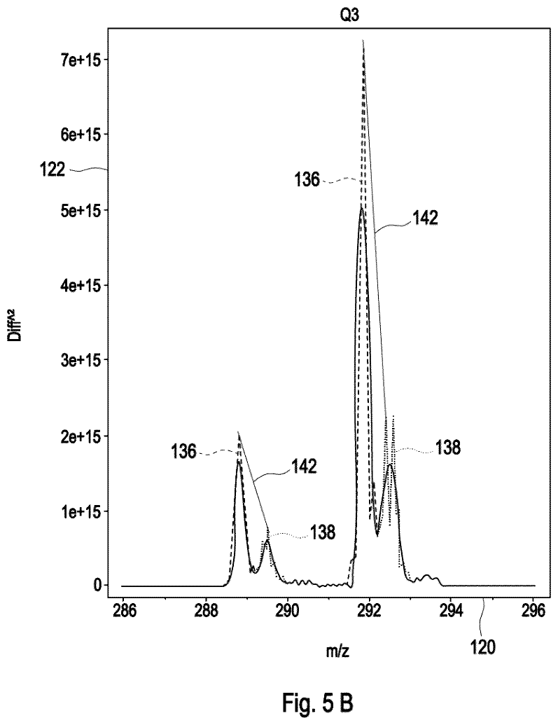

FIG. 5A shows an exemplary diagram of the calculated square differences depending on a mass to charge ratio of the first analyzing cell;

FIG. SB shows an exemplary diagram of the calculated square differences depending on a mass to charge ratio of the third analyzing cell;

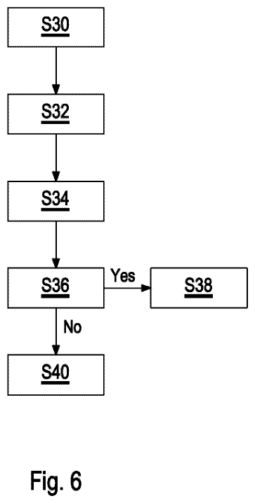

FIG. 6 shows a flow chart of a method for characterization of a mass spectrometry instrument according to a second embodiment;

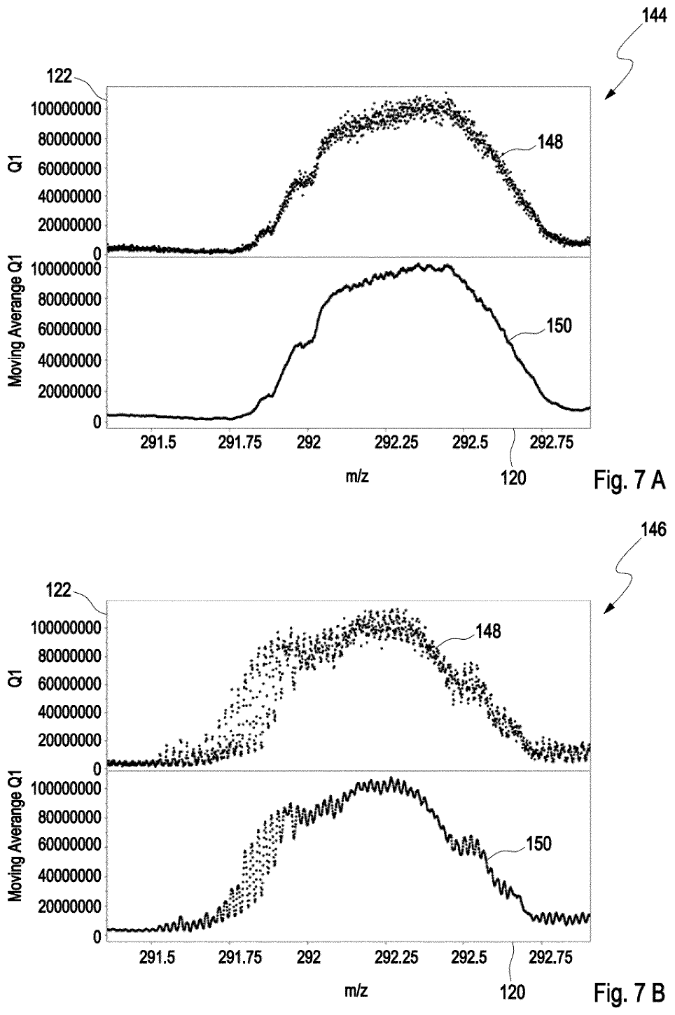

FIG. 7A shows an exemplary third mass spectrum of the first analyzing cell;

FIG. 7B shows an exemplary fourth mass spectrum of the third analyzing cell;

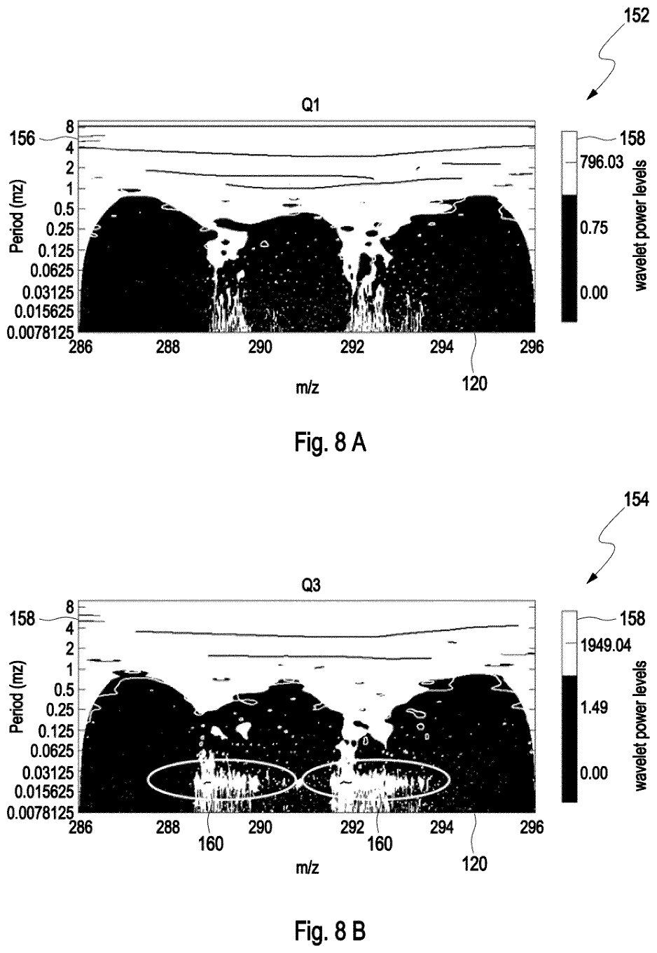

FIG. 8A shows an exemplary first heat map of the first analyzing cell;

FIG. 8B shows an exemplary second heat map of the third analyzing cell;

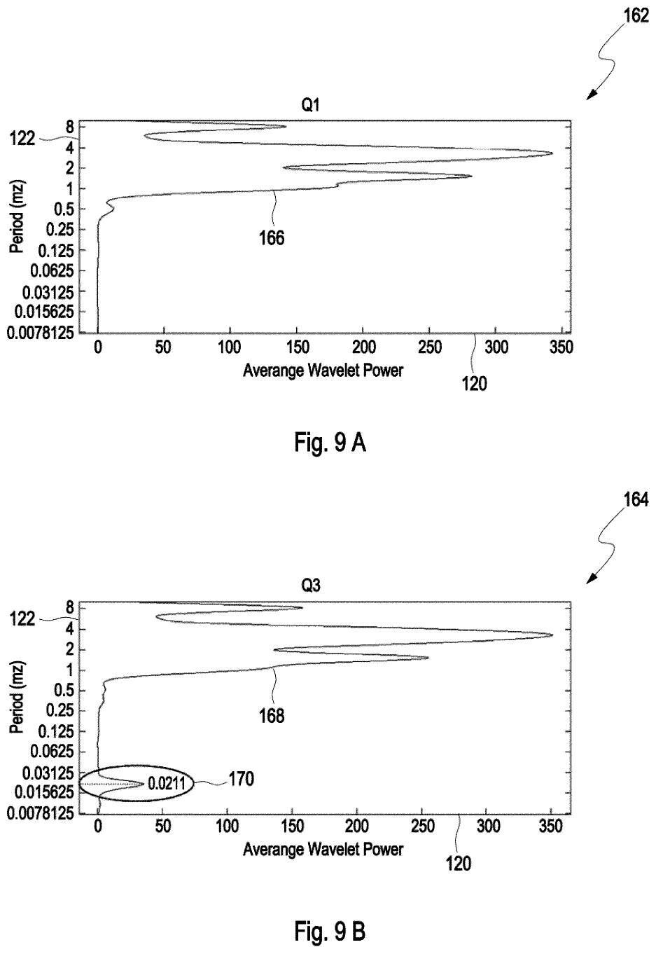

FIG. 9A shows an exemplary first wavelet transformation diagram of the first analyzing cell;

FIG. 9B shows an exemplary second wavelet transformation diagram of the third analyzing cell;

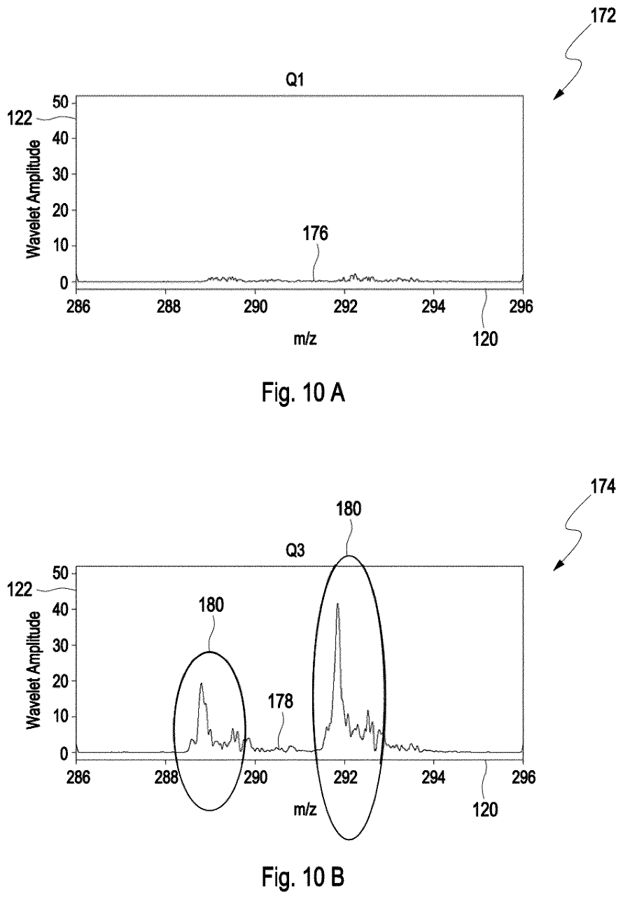

FIG. 10A shows an exemplary first wavelet amplitude diagram of the first analyzing cell; and

FIG. 10B shows an exemplary second wavelet amplitude diagram of the third analyzing cell.

### DETAILED DESCRIPTION OF THE EMBODIMENTS

FIG. 1 shows a schematic illustration mass spectrometry instrument 100. The mass spectrometry instrument 100 comprises at least one mass analyzing cell 102. In the present exemplary embodiment, the mass spectrometry instrument 100 is a triple quadrupole mass spectrometer comprising three analyzing cells 102, 104, 106. Thus, each of analyzing cells 102, 104, 106 is a quadrupole. Particularly, the mass spectrometry instrument 100 comprises a first analyzing cell 102, a second analyzing cell 104 and a third analyzing cell 106 which are arranged so as to build up a tandem mass spectrometer consisting of two quadrupole mass filters 102, 106 in series, with a (non-mass-resolving) radio frequency (RF) only quadrupole between them to act as a cell 104 for collision-induced dissociation. The mass spectrometry instrument 100 further comprises an ionization source 108 such as an electrospray ionisation (ESI) or atmospheric pressure chemical ionization (APCI) source arranged adjacent the first analyzing cell 102 and to which a sample 110 may be input. The mass spectrometry instrument 100 further comprises a particle multiplier 112 arranged adjacent the third analyzing cell 106 and configured to provide an output signal 114. With this arrangement, the sample 110 is ionized at the ionization source. The first analyzing cell 102 makes a mass to charge selection (m/z selection) of the sample ions. The second analyzing cell 104 makes a fragmentation of the sample ions. The third analyzing cell 106 makes a mass to charge selection (m/z selection) of the fragments of the sample ions. As the basic operation principle of such a mass spectrometry instrument is known to the skilled person, e.g. from the prior art as described above, any further description of the operation principle thereof is omitted. Some conventional mass spectrometry instruments have a rather low resolution of 20 Points/Da. The determination of the maximum signal intensity (precision of mass calibration) and the full width at half maximum of the maximum signal intensity (separation efficiency to neighbour ions) can be done very easy. However, shifts or other changes in the signal are not precise enough to be monitored. In the present embodiment, the mass spectrometry instrument 100 has a higher resolution which is limited to 0.0076 Da, thereby allowing a data evaluation with higher precision of 1000 Points/Da.

FIG. 2 shows a flow chart of a method for characterization of a mass spectrometry instrument 100 comprising at least one mass analyzing cell 102 according to a first embodiment of the present disclosure. The method of the present disclosure starts with a step S10 in which a sample 110 comprising at least one substance having a known molecular weight is analyzed by means of the mass spectrometry instrument 100 so as to provide a mass spectrum of the sample 110. Subsequently, the method proceeds further to step S12 in which an outer envelope and an inner envelope of the mass spectrum are determined. Subsequently, the method proceeds further to step S14 in which a squared difference between the outer envelope and the inner envelope is calculated. Subsequently, the method proceeds further to step S16 in which a deviation of the calculated squared difference from a theoretical mass to charge ratio value of the substance is determined. Subsequently, the method proceeds further to step S18 in which it is determined whether the determined deviation of the calculated difference from a theoretical mass to charge ratio value of the substance exceeds a predetermined difference threshold. If the determined deviation of the calculated difference exceeds the predetermined difference threshold, the method proceeds further to step S20 in which an improper status of the mass spectrometry instrument is determined. To the contrary, if the determined deviation of the calculated difference does not exceed the predetermined difference threshold, the method proceeds further to step S22 in which a proper status of the mass spectrometry instrument is determined. The method may be carried out for each mass analyzing cell 102, 104, 106.

The method and optional modifications thereof will be described in further detail below.

FIG. 3A shows an exemplary first mass spectrum 116 of the first analyzing cell 102 for testosterone and its internal standard analyzed with the mass spectrometry instrument 100 of the present embodiment. FIG. 3B shows an exemplary second mass spectrum 118 of the third analyzing cell 106 for testosterone and its internal standard analyzed with the mass spectrometry instrument 100 of the present embodiment. In FIGS. 3A and 3B, the mass to charge ratio (m/z ratio) is given as the x-axis 120. The signal intensity in % is given as the y-axis 122. Graph 124 denotes the signal intensity depending on the mass to charge ratio. As can be taken from FIG. 3A, a less distinguished front shoulder 126 can be found and in the higher region there are multiple maxima 128. Thus, a data evaluation with higher resolution and data points could lead to a better calibration efficiency. As can be taken from FIG. 3B, differences in quadrupoles can be found, e.g. a left raising flank 130 is more noisy than a right descending flank 132. Thus, the method according to the present disclosure is based on the findings that a fingerprint characterization of quadrupoles is possible based on the behavior of the mass spectrum such as a system specific or longtime effect monitoring.

FIG. 4A shows an exemplary first mass spectrum 116 of the first analyzing cell 102 for testosterone and its internal standard analyzed with the mass spectrometry instrument 100 of the present embodiment. FIG. 4B shows an exemplary second mass spectrum 118 of the third analyzing cell 106 for testosterone and its internal standard analyzed with the mass spectrometry instrument 100 of the present embodiment. Hereinafter, only the differences from FIGS. 3A and 3B are described and like features are indicated by like reference signs. As shown in FIGS. 4A and 4B, the method according to the present disclosure further comprises a step of determining an outer envelope fₒ and an inner envelope fᵢ of the mass spectrum 116, 118. The y-axis 122 indicates a signal intensity, an outer envelope fₒ and an inner envelope fᵢ of the mass spectrum 116, 118. A difference of outer envelope fₒ and inner envelope fᵢ leads to a left sided relative spectra which can further characterize the status of the quadrupole. Variances of environmental conditions, like humidity temperature and pressure, or contamination of the matrix provided by the sample 110 can be visualized with this “macroscopic” finger print characterization. As can be taken from a comparison of FIGS. 4A and 4B, the envelopes fₒ and fᵢ of the first mass spectrum 116 of the first analyzing cell 102 are more symmetric, than of the second mass spectrum 118 of the third analyzing cell 106 where the outer envelope fₒ shows a bulge 134 on the left side.

The method according to the present disclosure further comprises a step of calculating a squared difference between the outer envelope fₒ and the inner envelope fᵢ. The squared difference between the outer envelope and the inner envelope is calculated as (fₒ−fᵢ)², wherein fₒ is the outer envelope and fᵢ is the inner envelope.

FIG. 5A shows an exemplary diagram of the thus calculated square differences depending on a mass to charge ratio (m/z ratio) of the first analyzing cell 102. FIG. 5B shows an exemplary diagram of the thus calculated square differences depending on a mass to charge ratio (m/z ratio) of the third analyzing cell 106. Hereinafter, only the differences from FIGS. 3A and 3B are described and like features are indicated by like reference signs. In FIGS. 5A and 5B, the mass to charge ratio (m/z ratio) is given as the x-axis 120. The calculated square differences between the outer envelope fₒ and the inner envelope fᵢ is given as the y-axis 122. Graph 136 denotes the calculated square differences depending on a mass to charge ratio (m/z ratio) at a left side from the theoretical value. Graph 138 denotes the calculated square differences depending on a mass to charge ratio (m/z ratio) at a right side from the theoretical value. As can be taken from a comparison of FIGS. 5A and 5B, the squared differences between the envelopes fₒ, fᵢ are for the third analyzing cell 106 much higher.

The method according to the present disclosure further comprises a step of determining a deviation of the calculated squared difference from a theoretical mass to charge ratio value of the substance. The deviation of the calculated difference is determined along a mass to charge ratio axis of the mass spectrum. Particularly, the deviation of the calculated difference is determined based on a position left and a position right of the theoretical mass value of the substance along the mass to charge ratio axis of the mass spectrum. Determining the deviation includes determining a ratio of the peak at the position left and the peak at the position right of the theoretical mass value of the substance along the mass to charge ratio axis of the mass spectrum. The peak height ratio of the calculated squared differences equals approximately 1 for left and right side in case of symmetry as indicated by line 140 in FIG. 5A. For asymmetry, this is not the case and a height difference can be determined as indicated by line 142 in FIG. 5B. Thus, a proper status of the mass spectrometry instrument 100 is determined if the determined deviation of the calculated difference does not exceed a predetermined difference threshold, for example as shown by the approximately same peak height in FIG. 5A. To the contrary, an improper status of the mass spectrometry instrument 100 is determined if the determined deviation of the calculated difference exceeds a predetermined difference threshold, for example as shown by the different peak height in FIG. 5B.

FIG. 6 shows a flow chart of a method for characterization of a mass spectrometry instrument 100 comprising at least one mass analyzing cell 102 according to a second embodiment of the present disclosure. It is explicitly stated that the method of the second embodiment may be combined with the method of the first embodiment, for example in case the calculated difference does not exceed the predetermined difference threshold. Needless to say, the method of the second embodiment may be carried out independent on the method of the first embodiment. The method of the present disclosure starts with a step S30 in which a sample 110 comprising at least one substance having a known molecular weight is analyzed by means of the mass spectrometry instrument 100 so as to provide a mass spectrum of the sample 110. Subsequently, the method proceeds further to step S32 in which a wavelet transformation of the mass spectrum is made. Subsequently, the method proceeds further to step S34 in which a deviation of an amplitude of the wavelet transformed mass spectrum from a theoretical amplitude value of the substance at a predetermined period is determined. Subsequently, the method proceeds further to step S36 in which it is determined whether the determined deviation of the amplitude of the wavelet transformed mass spectrum from the theoretical amplitude value of the substance at the predetermined period exceeds a predetermined amplitude threshold. If the determined deviation of the amplitude of the wavelet transformed mass spectrum from the theoretical amplitude value of the substance at the predetermined period exceeds the predetermined amplitude threshold, the method proceeds further to step S38 in which an improper status of the mass spectrometry instrument is determined. To the contrary, if the determined deviation of the amplitude of the wavelet transformed mass spectrum from the theoretical amplitude value of the substance at the predetermined period does not exceed the predetermined amplitude threshold, the method proceeds further to step S40 in which a proper status of the mass spectrometry instrument is determined. The method may be carried out for each mass analyzing cell 102, 104, 106.

The method and optional modifications thereof will be described in further detail below.

FIG. 7A shows an exemplary third mass spectrum 144 of the first analyzing cell 102 for testosterone analyzed with the mass spectrometry instrument 100 of the present embodiment. FIG. 7B shows an exemplary fourth mass spectrum 146 of the third analyzing cell 106 for testosterone analyzed with the mass spectrometry instrument 100 of the present embodiment. In FIGS. 7A and 7B, the mass to charge ratio (m/z ratio) is given as the x-axis 120. The signal intensity and the moving average of the signal intensity are given as the y-axis 122. Graph 148 shown in the upper portion of FIGS. 7A and 7B denotes the signal intensity depending on the mass to charge ratio. Graph 150 shown in the lower portion of FIGS. 7A and 7B denotes the moving average of the signal intensity depending on the mass to charge ratio.

The method of the second embodiment is based on the findings that among others an alternative method to characterize the mass spectra is to look “microscopic” at the wavelet transformation of the signal. At the frequency of the noise, a higher amplitude in the fourth mass spectrum 146 of the third analyzing cell 106 can be expected if compared to the third mass spectrum 144 of the first analyzing cell 102.

The method further comprises creating a heatmap of the wavelet transformed mass spectrum and determining the deviation of the amplitude at the predetermined period in the heatmap. Particularly, the deviation of the amplitude at the predetermined period is determined depending on a wavelet power.

FIG. 8A shows an exemplary first heat map 152 of the first analyzing cell 102 for testosterone analyzed with the mass spectrometry instrument 100 of the present embodiment. FIG. 8B shows an exemplary second heat map 154 of the third analyzing cell 106 for testosterone analyzed with the mass spectrometry instrument 100 of the present embodiment. In FIGS. 8A and 8B, the mass to charge ratio (m/z ratio) is given as the x-axis 120. The period (mz) is given as the left y-axis 156. The wavelet power levels are indicated as the right y-axis 158, wherein high wavelet power levels are indicated as white and low or lower wavelet power levels are indicated as grey or black for reasons of simplification. As indicated by circles 160 in the second heat map 154 of the third analyzing cell 106, regions with highest amplitude at the predetermined period may be observed within the second heat map 154 of the third analyzing cell 106.

FIG. 9A shows an exemplary first wavelet transformation diagram 162 of the first analyzing cell 102 for testosterone analyzed with the mass spectrometry instrument 100 of the present embodiment. FIG. 9B shows an exemplary second wavelet transformation diagram 164 of the third analyzing cell 106 for testosterone analyzed with the mass spectrometry instrument 100 of the present embodiment. In FIGS. 9A and 9B, the average wavelet power is given as the x-axis 120. The period (mz) is given as the y-axis 122. Graph 166 shown in FIG. 9A denotes the wavelet transformed third mass spectrum 144 of the first analyzing cell 102. Graph 168 shown in FIG. 9B denotes the wavelet transformed fourth mass spectrum 146 of the third analyzing cell 106. As shown by graph 166, no salient signal below 1 period is present first wavelet transformation diagram 162 of the first analyzing cell 102. As indicated by circle 170, with the thus marked predetermined period, a higher amplitude can be observed only for the third analyzing cell 106 by a salient signal at 0.02 period/5 kHz.

FIG. 10A shows an exemplary first wavelet amplitude diagram 172 of the first analyzing cell 102 for testosterone analyzed with the mass spectrometry instrument 100 of the present embodiment. FIG. 10B shows an exemplary second wavelet amplitude diagram 174 of the third analyzing cell 106 for testosterone analyzed with the mass spectrometry instrument 100 of the present embodiment. In FIGS. 10A and 10B, the the mass to charge ratio m/z is given as the x-axis 120. The wavelet amplitude is given as the y-axis 122. Graph 176 shown in FIG. 10A denotes the wavelet amplitude of the third mass spectrum 144 of the first analyzing cell 102 depending on the mass to charge ratio m/z. Graph 178 shown in FIG. 10B denotes the wavelet amplitude of the fourth mass spectrum 146 of the third analyzing cell 106 depending on the mass to charge ratio m/z. As shown by graph 176, the wavelet amplitude does not show a salient signal at 0.02 period/5 kHz. As indicated by circles 180, there is a high wavelet amplitude at around 0.02 period/5 kHz as the signal is highest at the positions of the mass spectral peaks.

Thus, a proper status of the mass spectrometry instrument 100 is determined if the determined deviation of the amplitude does not exceed a predetermined amplitude threshold, for example as shown by the missing peak or amplitude in FIG. 9A. To the contrary, an improper status of the mass spectrometry instrument 100 is determined if the determined deviation of the amplitude exceeds a predetermined amplitude threshold, for example as shown by the peak or amplitude in FIG. 9B.

The method according to each of the embodiments described herein may use the following exemplary parameters for the classification of a proper/normal or improper/abnormal status of the mass spectrometry instrument 100.

Concerning the resolution in Da, a proper status may be defined as 0.8±0.1 and an improper status may be defined as <0.7 and >0.9. Concerning the accuracy, i.e. mass axis position, in Da, a proper status may be defined as tolerance for shifts of ±0.1 and an improper status may be defined as shifts >0.1. Concerning the high precision characterization, i.e. multiple systems with machine learning, a proper status may be defined as comparable to other systems and no shifts over time or environmental changes and an improper status may be defined as quadrupole is not comparable to other systems and shifts over time or environmental changes. Concerning the envelope characterization, a proper status may be defined as an symmetric arrangement of the outer and inner envelopes and an improper status may be defined as an asymmetric arrangement of the outer and inner envelopes. Concerning the wavelet or Fourier transformation, a proper status may be defined as no characteristic frequency and an improper status may be defined as an interference of the signal with noise frequency.

The method according to each of the embodiments described herein is carried out at predetermined points of time. Particularly, the points of time include at least a start of the mass spectrometry instrument 100. For example, the method is carried out as a predictive maintenance measure. The method according to each of the embodiments described herein g may be computer-implemented. For example, the method may be automatically carried out under control of a computer or computer system. Alternatively to a wavelet transformation, a Fourier transformation may be feasible.

### LIST OF REFERENCE NUMBERS

100 mass spectrometry instrument
102 first analyzing cell
104 second analyzing cell
106 third analyzing cell
108 ionization source
110 sample
112 particle multiplier
114 signal
116 first mass spectrum of first analyzing cell
118 second mass spectrum of third analyzing cell
120 x-axis
122 y-axis
124 signal intensity depending on the mass to charge ratio
126 front shoulder
128 maximum
130 left raising flank
132 right descending flank
134 bulge
136 calculated square differences depending on a mass to charge ratio at a left side from the theoretical value
138 calculated square differences depending on a mass to charge ratio at a right side from the theoretical value
140 symmetric peak height ratio
142 asymmetric peak height ratio
144 third mass spectrum of first analyzing cell
146 fourth mass spectrum of third analyzing cell
148 signal intensity depending on the mass to charge ratio
150 moving average of the signal intensity depending on the mass to charge ratio
152 exemplary first heat map of first analyzing cell
154 exemplary second heat map of third analyzing cell
156 left y-axis
158 right y-axis
160 region with highest amplitude at predetermined period
162 first wavelet transformation diagram of first analyzing cell
164 second wavelet transformation diagram of third analyzing cell
166 wavelet transformed third mass spectrum of the first analyzing cell
168 wavelet transformed fourth mass spectrum of the third analyzing cell
170 predetermined period
172 first wavelet amplitude diagram of the first analyzing cell
174 second wavelet amplitude diagram of the third analyzing cell
176 wavelet amplitude of the third mass spectrum of the first analyzing cell depending on the mass to charge ratio m/z
178 wavelet amplitude of the fourth mass spectrum of the third analyzing cell
180 a high wavelet amplitude
S10 analyzing sample
S12 determining outer envelope and inner envelope of the mass spectrum
S14 calculating squared difference between outer envelope and inner envelope
S16 determining deviation of calculated squared difference from theoretical mass to charge ratio value of the substance
S18 determining whether determined deviation of the calculated difference from theoretical mass to charge ratio value of the substance exceeds predetermined difference threshold
S20 determining improper status of the mass spectrometry instrument
S22 determining proper status of the mass spectrometry instrument
S30 analyzing sample comprising at least one substance having known molecular weight
S32 making wavelet transformation of the mass spectrum
S34 determining deviation of an amplitude of the wavelet transformed mass spectrum from theoretical amplitude value of the substance at a predetermined period
S36 determining whether determined deviation of the amplitude of the wavelet transformed mass spectrum from the theoretical amplitude value of the substance at the predetermined period exceeds predetermined amplitude threshold
S38 determining improper status of the mass spectrometry instrument
S40 determining proper status of the mass spectrometry instrument

1. A method for characterization of a mass spectrometry instrument comprising at least one mass analyzing cell, the method comprising:
analyzing, by the mass spectrometry instrument, a sample comprising at least one substance having a known molecular weight so as to provide a mass spectrum of the sample;
determining, by the mass spectrometry instrument, an outer envelope and an inner envelope of the mass spectrum;
determining, by the mass spectrometry instrument, a squared difference between the outer envelope and the inner envelope; and
determining, by the mass spectrometry instrument, a deviation of the squared difference from a theoretical mass-to-charge ratio value of the at least one substance.

2. The method of claim 1, wherein the squared difference between the outer envelope and the inner envelope is calculated as (fₒ−fᵢ)², wherein fₒ is the outer envelope and fᵢ is the inner envelope.

3. The method of claim 1, further comprising determining, by the mass spectrometry instrument, the deviation of the squared difference along a mass-to-charge ratio axis of the mass spectrum.

4. The method of claim 3, wherein determining the deviation of the squared difference comprises determining the deviation of the squared difference based on a position left and a position right of the theoretical mass-to-charge ratio value of the at least one substance along the mass-to-charge ratio axis of the mass spectrum.

5. The method of claim 4, wherein determining the deviation of the squared difference comprises determining a ratio of the peak at the position left and the peak at the position right of the theoretical mass-to-charge ratio value of the at least one substance along the mass-to-charge ratio axis of the mass spectrum.

6. The method of claim 1, further comprising determining, by the mass spectrometry instrument, an improper status of the mass spectrometry instrument if the determined deviation of the squared difference exceeds a predetermined difference threshold.

7. The method of claim 6, further comprising:
generating, by the mass spectrometry instrument, a wavelet transformation of the mass spectrum; and
determining, by the mass spectrometry instrument, a deviation of an amplitude of the wavelet transformed mass spectrum from a theoretical amplitude value of the at least one substance at a predetermined period.

8. The method of claim 7, wherein generating the wavelet transformation of the mass spectrum, and determining the deviation of the amplitude of the wavelet transformed mass spectrum from the theoretical amplitude value of the at least one substance at the predetermined period is carried out if the determined deviation of the squared difference does not exceed the predetermined difference threshold.

9. The method of claim 8, further comprising determining, by the mass spectrometry instrument, an improper status of the mass spectrometry instrument if the determined deviation of the amplitude exceeds a predetermined amplitude threshold.

10. A method for characterization of a mass spectrometry instrument comprising at least one mass analyzing cell, the method comprising:
analyzing, by the mass spectrometry instrument, a sample comprising at least one substance having a known molecular weight by means of the mass spectrometry instrument so as to provide a mass spectrum of the sample;
generating, by the mass spectrometry instrument, making a wavelet transformation of the mass spectrum; and
determining, by the mass spectrometry instrument, a deviation of an amplitude of the wavelet transformed mass spectrum from a theoretical amplitude value of the at least one substance at a predetermined period.

11. The method of claim 10, further comprising:
creating, by the mass spectrometry instrument, a heatmap of the wavelet transformed mass spectrum; and
determining, by the mass spectrometry instrument, the deviation of the amplitude at the predetermined period in the heatmap.

12. The method of claim 10, further comprising determining, by the mass spectrometry instrument, the deviation of the amplitude at the predetermined period depending on a wavelet power.

13. The method of claim 10, further comprising determining, by the mass spectrometry instrument, an improper status of the mass spectrometry instrument if the determined deviation of the amplitude exceeds a predetermined amplitude threshold.

14. The method of claim 10, wherein the mass spectrometry instrument comprises more than one mass analyzing cell, wherein analyzing the sample, generating the wavelet transformation, and determining the deviation of the amplitude are performed for each mass analyzing cell of the more than one mass analyzing cell.

15. The method of claim 10, wherein analyzing the sample, generating the wavelet transformation, and determining the deviation of the amplitude are performed at predetermined points of time.

16. The method of claim 15, wherein at least one of the predetermined points of time comprises a start of the mass spectrometry instrument.

17. A mass spectrometry instrument, the mass spectrometry instrument comprising:
a processor; and
a memory comprising a plurality of instructions stored thereon that, in response to execution by the processor, causes the mass spectrometry instrument to:
analyze a sample comprising a substance having a known molecular weight to generate a mass spectrum of the sample;
determine an outer envelope and an inner envelope of the generated mass spectrum;
determine a squared difference between the outer envelope and the inner envelope of the generated mass spectrum;
determine a deviation of the squared difference from a theoretical mass-to-charge ratio value of the substance;
determine whether the deviation of the squared difference exceeds a predetermined difference threshold; and
automatically classify a state of the mass spectrometry instrument, wherein the state of the mass spectrometry instrument is classified as normal in response to a determination that the deviation of the squared difference does not exceed the predetermined difference threshold, and wherein the state of the mass spectrometry instrument is classified as abnormal in response to a determination that the deviation of the squared difference exceeds the predetermined difference threshold.

18. The mass spectrometry instrument of claim 17, wherein to determine the deviation of the squared difference from a theoretical mass-to-charge ratio value comprises to determine the deviation of the squared difference along a mass-to-charge ratio axis of the mass spectrum based on a position left and a position right of the theoretical mass-to-charge ratio value of the substance along the mass-to-charge ratio axis of the mass spectrum.

19. The mass spectrometry instrument of claim 18, wherein to determine the deviation of the squared difference along a mass-to-charge ratio axis of the mass spectrum based on the position left and the position right of the theoretical mass-to-charge ratio value of the substance along the mass-to-charge ratio axis of the mass spectrum comprises to determine a peak height ratio of a peak at the position left and a peak at the position right of the theoretical mass-to-charge ratio value of the at least one substance.

20. The mass spectrometry instrument of claim 17, further comprising at least one mass analyzing cell.
